(19) United States
(12) Patent Application Publication
(10) Pub. No.: US 2016/0034614 A1
(43) Pub. Date: Feb. 4, 2016

(54) MATERIALS PROPERTY PREDICTOR FOR CAST ALUMINUM ALLOYS

(71) Applicant: GM Global Technology Operations LLC, Detroit, MI (US)

(72) Inventors: Qigui Wang, Rochester Hills, MI (US); Bing Li, Rochester Hills, MI (US); Yucong Wang, West Bloomfield, MI (US)

(21) Appl. No.: 14/449,324

(22) Filed: Aug. 1, 2014

(51) Int. Cl. G06F 17/50; B22D 21/00; B22D 46/00

(52) U.S. Cl. CPC G06F 17/5009; B22D 46/00; B22D 21/007

(57) ABSTRACT

A device and article of manufacture to predict material properties of a cast aluminum-based component. In one form, a computer-based system includes numerous computation modules programmably cooperative with one another such that upon receipt of data that corresponds to the cast aluminum-based component, the modules provide performance indicia of the material. The modules include a thermodynamic calculation module, a thermal-physical property module, a mechanical property module and a materials selection or alloy design module. The combination of the modules along with known material and geometric databases—in addition to microstructural and defect databases—promotes the generation of materials properties needed for casting design, casting process simulation, CAE nodal property mapping and durability analysis.

### BACKGROUND OF THE INVENTION

The present invention relates generally to the predicted mechanical properties of cast components and, more particularly to systems, methods, and articles of manufacture to provide an integrated computational way to generate thermodynamic, thermal-physical, and mechanical material properties for cast aluminum alloy components based on the property requirements for such components.

Many critical structural applications utilize cast components or products. This is especially true for automotive and related transportation systems, where engines, transmissions, suspension systems, load-bearing primary structures, seating components, interior support structures or the like have all benefited from the low-cost manufacturing associated with casting. Casting processes are often the most cost effective method to produce geometrically complex components and offer net shape or near net-shape capability in comparison with other manufacturing processes. Such casting processes are especially beneficial when used in conjunction with lightweight structural materials, such as aluminum-based alloys, where high strength to weight ratios, good corrosion resistance, and relatively low raw material cost are useful design parameters.

Relatively recent advancements in computer-based tools have enabled improvements in component design for components made through casting. Computer aided engineering (CAE)—which may also include computer-aided analysis (CAA), computer aided design (CAD), computer aided manufacturing (CAM), computer-aided planning (CAP), computer-integrated manufacturing (CIM), material requirements planning (MRP) or the like—can be utilized to not only predict how to design and manufacture a complex cast component, but also predict how the component will perform in its intended operating environment.

Efforts have been made to integrate some of these traditionally discrete, independent disciplines as a way to reduce long casting development cycles, as well as improve casting quality, reliability and other indicia of component integrity. One such effort is known as Integrated Computational Materials Engineering (ICME), which focuses on employing computer-based tools to improve the development of cast components by linking processes and structures to their corresponding properties to computationally simulate component performance prior to undertaking any actual fabrication-related activities. Despite the advantages associated with ICME and related approaches, initial simplifying assumptions must still be made with regard to casting design, process modeling and optimization, as well as prediction of defects, microstructure and product performance. Particularly problematic is that certain properties (for example, the material properties) are conventionally assumed to be substantially uniform through the object being simulated. Unfortunately, many such objects do not exhibit such uniformity in their material properties, especially those where highly complex shapes or significant differences in component thickness are present. For example, automotive engine blocks have numerous thick and thin regions that hamper the ability to assess material properties and accurately conduct related durability and life prediction analyses. Neglecting the effect of material property variations arising out of particular casting configurations manifests itself in inaccuracies in casting process simulations, including the determination of long-term component durability predictions.

As such, systems, methods and articles of manufacture to accurately account for material properties of casting process simulation are lacking. Likewise, CAE and related analysis methods used to conduct durability analyses for cast aluminum components could be improved based on a better prediction of these underlying material properties.

### SUMMARY OF THE PRESENT INVENTION

The present invention enables more accurate prediction of material properties that can be used in casting process simulation studies. The present invention allows a modeler to combine properties from various databases—including, but not limited to, a material property database, a thermodynamic database, and a defects and microstructure database—with various integrated modules to predict the properties of a selected aluminum-based material that will be used in a casting operation to manufacture a particular component.

According to an aspect of the present invention, a device for predicting properties of a material used in a cast aluminum component is disclosed. The device includes computational elements made up of a data input, a data output, one or more processing units and one or more data-containing and instruction-containing memories that are cooperative with one another through a data communication path. Various functional (i.e., computation) modules are configured to be programmably cooperative with one or more of these computational elements such that upon receipt of data pertaining to one or more of the component, casting process and material being modeled, the device subjects the data to the functional modules in order that generated output data provides performance indicia of the material selected for the particular component and process. The modules include at least, but not limited to, (1) a thermodynamic phase calculation module, (2) a thermal-physical property module, (3) a mechanical property prediction module and (4) a materials selection/alloy design module.

According to another aspect of the present invention, an article of manufacture is disclosed. The article includes a computer usable medium with computer readable program code embodied therein for a plurality of modules programmably cooperative with one another to generate various material (including thermodynamic, thermal-physical and mecahnical) properties of an aluminum-based alloy for use in one or more of casting design, casting process simulation and CAE nodal property mapping and durability analyses for a particular cast component being modeled. The modules are similar to those discussed above in conjunction with the previous aspect.

### BRIEF DESCRIPTION OF THE DRAWINGS

The following detailed description of specific embodiments can be best understood when read in conjunction with the following drawings, where like structure is indicated with like reference numerals and in which:

FIG. 1 shows a device implemented on a computer according to one embodiment of the present invention;

FIG. 2 shows a block diagram with cooperation among various functional modules that make up a materials property predictor according to an embodiment of the present invention;

FIGS. 3A through 3C show how solid back diffusion may be used to model thermodynamic equilibrium and non-equilibrium conditions within one of the functional modules of FIG. 2;

FIGS. 4 and 5 show the use of a regression model for thermal property predictions within another of the functional modules of FIG. 2;

FIGS. 6 and 7 show one indicia of mechanical properties that takes into consideration defects and microstructural variation within another of the functional modules of FIG. 2; and

FIG. 8 shows some of the criteria used more casting process and material selection within another of the functional modules of FIG. 2.

The embodiments set forth in the drawings are illustrative in nature and are not intended to be limiting of the embodiments defined by the claims. Moreover, individual aspects of the drawings and the embodiments will be more fully apparent and understood in view of the detailed description that follows.

### DETAILED DESCRIPTION OF THE PREFERRED EMBODIMENTS

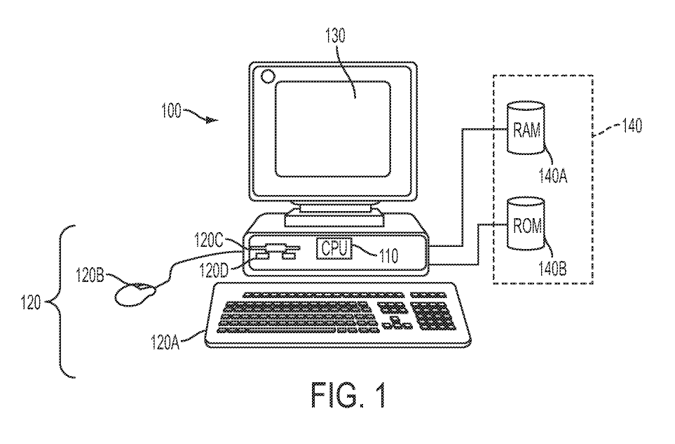

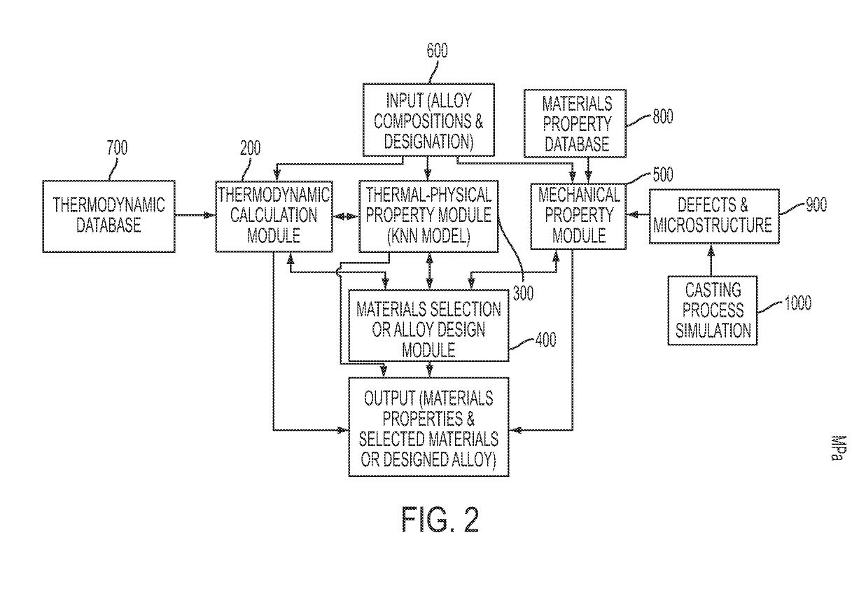

Referring first to FIGS. 1 and 2, in one aspect, the system used to predict material properties for a cast aluminum component is configured as a computer 100 or related data processing equipment. The computer 100 (regardless of whether configured as an autonomous device, workstation, mainframe or other form) includes a processing unit 110 (which may be in the form of one or more microprocessors), one or more mechanisms for information input 120 (including a keyboard 120A, mouse 120B or other device, such as a voice-recognition receiver (not shown), as well as an optical disk loader 120C or USB port 120D), a display screen or related information output 130, a memory 140 and computer-readable program code means (not shown) to process at least a portion of the received information relating to the cast aluminum alloy. As will be appreciated by those skilled in the art, memory 140 may be in the form of random-access memory (RAM) 140A (also called mass memory, which can be used for the temporary storage of data) and instruction-storing memory in the form of read-only memory (ROM) 140B. In addition to other forms of input not shown (such as through an internet or related connection to an outside source of data), the optical disk loader 120C or USB port 120D may serve as a way to load data or program instructions from one computer-usable medium (such as CD-ROM, flash drives or the like) to another (such as memory 140). A data bus or related set of wires and associated circuitry forms a suitable data communication path that can interconnect the input, output, CPU and memory, as well as any peripheral equipment in such a way as to permit the system to operate as an integrated whole. As will be appreciated by those skilled in the art, computer 100 may exist as an autonomous (i.e., stand-alone) unit, or may be the part of a larger network, such as those encountered in cloud computing, where various computation, software, data access and storage services may reside in disparate physical locations. Such a dissociation of the computational resources does not detract from such a system being categorized as a computer.

Referring with particularity to FIG. 2, in a particular form, the computer-readable program code means corresponds to the one or more modules (including thermodynamic phase calculation module 200, thermal-physical property (also called KNN) module 300, mechanical property module 500 or materials selection/alloy design module 400) that can be loaded into ROM 140B. Such computer-readable program code means may also be formed as part of an article of manufacture such that the instructions contained in the code are situated on a magnetically-readable or optically-readable disk or other related non-transitory, machine-readable medium, such as a flash memory device, CD-ROM, DVD-ROM, EEPROM, floppy disk or other such medium capable of storing machine-executable instructions and data structures. Such a medium is capable of being accessed by the computer 100 for interpreting instructions from the computer-readable program code of the numerous computational modules 200, 300, 400 or 500. Upon having the program code means loaded into ROM 140B, the computer 100 of system 1 becomes a specific-purpose machine configured to determine an optimal cast component in a manner as described herein. Data corresponding to a proposed component (for example, a cast aluminum alloy engine block) may be in the form of a database that may be stored in memory 140 or introduced into computer 100 via input 120 Likewise, casting design data and rules such as that embodied in the various modules can be stored in memory 140 or introduced into computer 100 via input 120. In another aspect, the system may be just the instruction code (including that of the various modules 200, 300, 400 or 500 that will be discussed in more detail below), while in still another aspect, the system may include both the instruction code and a computer-readable medium such as mentioned above.

It will also be appreciated by those skilled in the art that there are other ways to receive data and related information besides the manual input approach depicted in input 120 (especially in situations where large amounts of data are being input), and that any conventional means for providing such data in order to allow processing unit 110 to operate on it is within the scope of the present invention. As such, input 120 may also be in the form of high-throughput data line (including the internet connection mentioned above) in order to accept large amounts of code, input data or other information into memory 140. The information output 130 is configured to convey information relating to the desired casting approach to a user (when, for example, the information output 130 is in the form of a screen as shown) or to another program or model. It will likewise be appreciated by those skilled in the art that the features associated with the input 120 and output 130 may be combined into a single functional unit such as a graphical user interface (GUI), such as that shown and described in conjunction with an expert system in U.S. Pat. No. 7,761,263 entitled CASTING DESIGN OPTIMIZATION SYSTEM (CDOS) FOR SHAPE CASTINGS that is owned by the Assignee of the present invention and incorporated herein by reference.

In one form, input into the computer 100 may be through numerous databases, including one for alloy compositions and designation database 600, a thermodynamic database 700 and a materials property database 800. These databases and their cooperation with the various modules will be discussed in greater detail below. Two additional modules—defect & microstructure module 900 and casting process simulation module 1000—are configured to operate independently from the computational modules 200, 300, 400 and 500 of the present material property predictor system. Their purpose is to provide detailed information on defects and microstructure (such as dendrite arm spacing (DAS)) to the mechanical property module 500 that is discussed in more detail below. Details of the casting process simulation module 1000 and the defect & microstructure module 900 have been disclosed in two prior patents owned by the Assignee of the present invention and incorporated herein by reference: U.S. Pat. No. 8,355,894 entitled METHOD FOR SIMULATING CASTING DEFECTS AND MICROSTRUCTURES OF CASTINGS and U.S. PAT NO. 8,655,476 entitled SYSTEMS AND METHODS FOR COMPUTATIONALLY DEVELOPING MANUFACTURABLE AND DURABLE CAST COMPONENTS. Within the present context, the integration among the various modules 200 through 500 takes place in conjunction with input received by one or more of the aforementioned databases 600 through 800, as well as the external modules 900 and 1000. An example of such interaction is shown by the connecting arrows between the modules, where the thermal-physical property module 300 (discussed in more detail below) can receive data from the computer input 120 for data that corresponds to the chosen material from database 600, as well as exchange data with the thermodynamic calculation module 200.

The first of the functional modules is the thermodynamic calculation module 200. In one form, the thermodynamic phase fractions and phase diagrams of module 200 are calculated using the known calculation of phase diagram (CALPHAD) method, where inputs from the alloy compositions and designation database 600 and thermodynamic database 700 also include solidification (i.e., cooling rate) conditions. Significantly, unlike conventional thermodynamic approaches that only deal with equilibrium and partial non-equilibrium conditions, module 200 incorporates a third solidification condition (i.e., non-equilibrium) capable of performing solid back diffusion calculations as a way to predict actual phase fractions and phase diagrams in real casting conditions. In this way, equilibrium (lever rule) solidification assumptions—which hold that the solid-liquid interfaces move infinitely slow such that the compositions of the solid and liquid phases are uniform and always have the equilibrium compositions such that the diffusion coefficients are infinitely large in all phases so that the compositions of the solid and liquid phases at any temperature correspond to those given by the phase diagram—can by the present invention now be adjusted to account for non-equilibrium conditions in the actual casting. Likewise, the Scheil model normally refers to solidification of an alloy under partial non-equilibrium conditions in such a way that no diffusion occurs in the solid phase while exhibiting complete diffusion in the liquid phase. The assumptions made in the Scheil model are (in addition to no diffusion in the solid and complete diffusion in the liquid (uniform liquid composition)), local equilibrium at the solid/liquid interface, planar interface with negligible undercooling and no density difference between liquid and solid. The present inventors have determined that the actual solidification process is neither equilibrium nor partial non-equilibrium, noting with particularity that there is diffusion in the solidified metal, and moreover that the density is also different between the liquid and solid in the solidifying interface. The present solid back diffusion that is taken into consideration in module 200 corrects the simplifications made in the lever rule and Scheil models discussed above.

The thermodynamic database 700 of FIG. 2 is used to calculate precipitate equilibriums (such as the β phase in an Al—Si—Mg alloy such as Alloy 356, and the θ phase in an Al—Si—Mg—Cu alloy such as Alloys 318, 380 and 390); its data is combined with module 200 to perform the various equilibrium, partial non-equilibrium and non-equlibrium calculations discussed above. In one form, the thermodynamic database 700 is commercially available, an example of which is Pandat®.

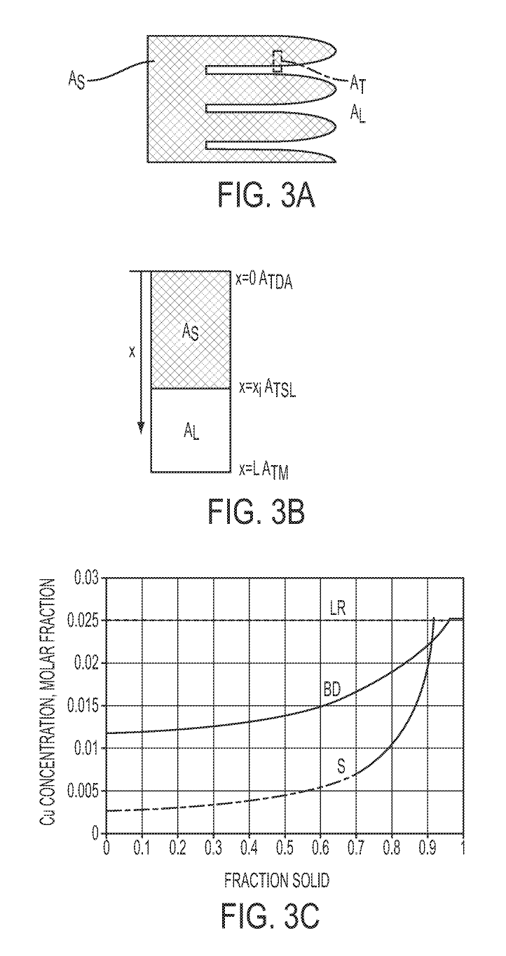

Referring next to FIGS. 3A through 3C, the solid back diffusion model of module 200 can account for the actual casting solidification condition, especially along a spatial dimension of dendritic structure where it transitions from solid to liquid through an interfacial region. Referring with particularity to FIGS. 3A and 3B, a notional sample of a castable aluminum alloy shows both solid A_{S} and liquid A_{L} regions, as well as a transitional region A_{T} where both solid and liquid attributes are present. FIG. 3B shows with even greater particularity the transitional region A_{T}, including subregions that correspond to the center of the dendrite arm A_{TDA}, the solid-liquid interface A_{TSL} and the midpoint between two dendrites A_{TM}.

Referring with particularity to FIG. 3C, a graph depicting the copper concentration in an aluminum-based alloy with 4.5% copper (an example of which is Alloy 380) is shown. The present solid back diffusion model BD, which can be represented by the following equation

C_{Lj}*(L−xₛ)+∫₀^{x}^{ₛ}C_{Sj}dx=C_{0 j}L

shows that features not accounted for (or improperly accounted for) in the underpredicting Scheil model S and the overpredicting lever rule model LR can be considered. In the equation, C_{Lj}* is the element j concentration in liquid at the solid/liquid interface, C_{S j} is the element j concentration profile in solid, C_{0 j} is the element j concentration in bulk material, L is the total length of the volume element which is half of the DAS, xₛ is the length of the volume element solidified and dx is the solid/liquid interface advanced during each time step. More accurate casting simulation is made possible because assumptions associated with each approach are combined to preserve the best attributes of each, while removing or reducing the negative externalities associated with such assumptions. For example, in the lever rule approach, it is assumed that there exists infinite diffusion in both liquid and solid, although in reality such infinite diffusion is never possible Likewise, in the Scheil approach, it is assumed that there is no diffusion in solid (which is not entirely accurate, either). The present inventors' back diffusion assumption takes into consideration a limited (finite) diffusion in the solid.

The comparison of the solute content evolution in the aluminum matrix during solidification shown—a expected—reveals that the lever rule model LR predicts high and uniform solute content in solid even from the start of solidification. At the end of solidification, the solute is uniform across the whole casting and there is no segregation. As stated above, this is never the case in practice. For the Scheil model S, the predicted solute content is lower in the first solidifying aluminum matrix and more in the final part; this too has been proven to be wrong in practice. The predicted solute content in the solidifying matrix by the back diffusion model BD is somewhere between lever rule and Scheil models LR, S; the present inventors have found that the predicted solute content profile using this approach is very close to reality.

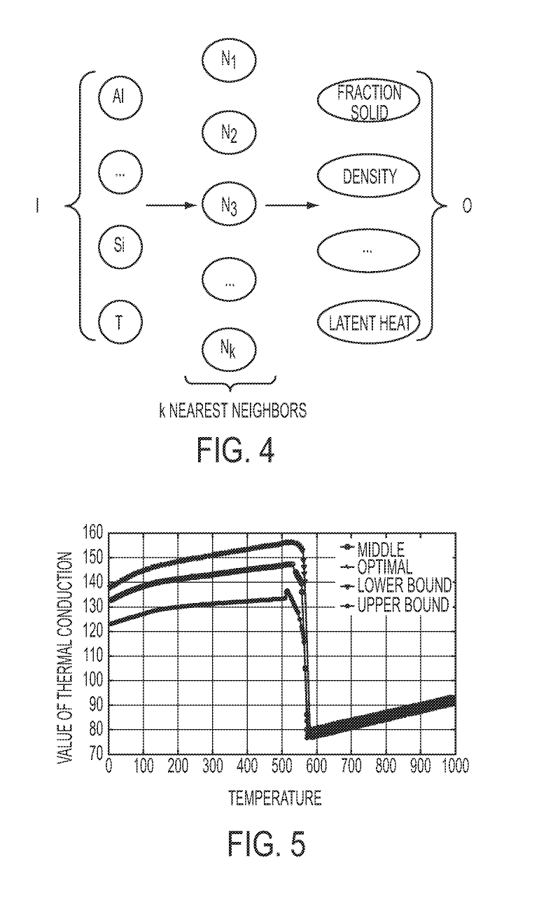

The second of the functional modules is the thermal-physical property module 300. Referring next to FIGS. 4 and 5, preferably, the thermal-physical properties module uses a newly developed k-nearest neighbor (KNN) based artificial intelligence regression model; this model was trained with both experimental and synthetic data the latter of which can be generated from commercially-available software (such as JMatPro®) such that the KNN model training covers all possible cast aluminum alloy compositions. Referring with particularity to FIG. 4, the input I variables for the model are alloy compositions (represented by the circles on the left, examples such as those provided by the alloy compositions and designation database 600) which cover the commonly used cast aluminum alloys such as 356, 319, 380, 390 or the like. The KNNs are shown as circles in the center, where the model uses the input I and finds the nearest nodal neighbors for the discretized mesh. Once the KNNs are established, the physical properties are calculated to produce output O, which includes eight thermal physical properties predicted in the module 300. Examples of which include, but are not limited to, density, thermal conductivity, latent heat, specific heat or the like. Mechanical property module predicts tensile and fatigue (both uniaxial and multiaxial) properties of cast aluminum alloys on both global uniform and local multi-scale defect and microstructure basis. Validation shows that the thermal physical properties predicted using the developed KNN model of module 300 are within 1% error compared with the commercial software predictions. In particular, FIG. 5 shows an example of one of the calculated thermal physical properties, thermal conductivity as a function of temperature; this information can be used by materials selection/alloy design module 400 to select an alloy from the designated thermal physical properties of the material. It can also be used by the thermal dynamic module 200 to calculate in-time phase balance, and also by the casting process simulation module 1000 and defect & microstructure module 900 should the need arise.

The following table highlights some of the thermal-physical properties that are generated as part of the module 300.

| PhysicalProperty Name | Best K Value | Best ARE | Best Method |
|---|---|---|---|
| Fraction solid | 11 | 0.0125 | Weighted KNN |
| Density | 7 | 0.0065 | Weighted KNN |
| Thermal conductivity | 11 | 0.0145 | Weighted KNN |
| Electrical conductivity | 11 | 0.0146 | Weighted KNN |
| Young's modulus | 7 | 0.0136 | Weighted KNN |
| Enthalpy | 9 | 0.0111 | Basic KNN |
| Specific heat | 9 | 0.0106 | Basic KNN |
| Latent heat | 7 | 0.0169 | Weighted KNN |

Significantly, in a KNN classification, the output is a class membership. An object is classified by a majority vote of its neighbors, with the object being assigned to the class most common among its k nearest neighbors (where k is a positive (and typically small) integer). In situations where k=1, then the object is simply assigned to the class of that single nearest neighbor. In a KNN regression, the output is the property value for the object. This k value is the average of the values of its k nearest neighbors. Likewise, the “Best ARE” column is the averaged relative error, while the column “Best Method” means for each thermal physical property there is one best method (either Weighted KNN or Basic KNN). In addition, with regard to “Weighted KNN” method, both for classification and regression, it can be useful to weight the contributions of the neighbors, so that the nearer neighbors contribute more to the average than the more distant ones. For example, a common weighting scheme consists in giving each neighbor a weight of 1/d, where d is the distance to the neighbor.

The third of the functional modules is the materials selection or alloy design module 400. This module offers the capability to select the alloy and related casting process based on the targeted mechanical and thermal physical properties at both room and elevated temperatures, as well as between one of optimized aluminum alloy compositions and target/required physical and mechanical properties. The mechanical properties include at least tensile and fatigue properties. The thermal properties include at least density, thermal conductivity, specific heat, coefficient of thermal expansion, Young's modulus or the like. The selection of the alloy to meet the targeted properties is accomplished by using intelligent searching engine. In the present context, an intelligent searching engine uses expert system technology to provide needed information from the knowledge database. One example of such a system is an inference engine which is a tool from the field of artificial intelligence, where the knowledge base stored facts about the subject and the inference engine applied logical rules to the knowledge base and deduced new knowledge. The iterative nature of the process allows additional rules within the inference engine to be triggered. Moreover, inference engines may work primarily in one of two modes: forward chaining and backward chaining, where the former starts with the known facts and asserts new facts and the latter with goals from which it works backward to determine what facts must be asserted so that the goals can be achieved. An example of the use of such forward chaining to perform casting design may be found in aforementioned U.S. Pat. No. 7,761,263. In one preferred form, the present inventors have determined that alloy selection and design in the present invention may also take advantage of the forward chaining method.

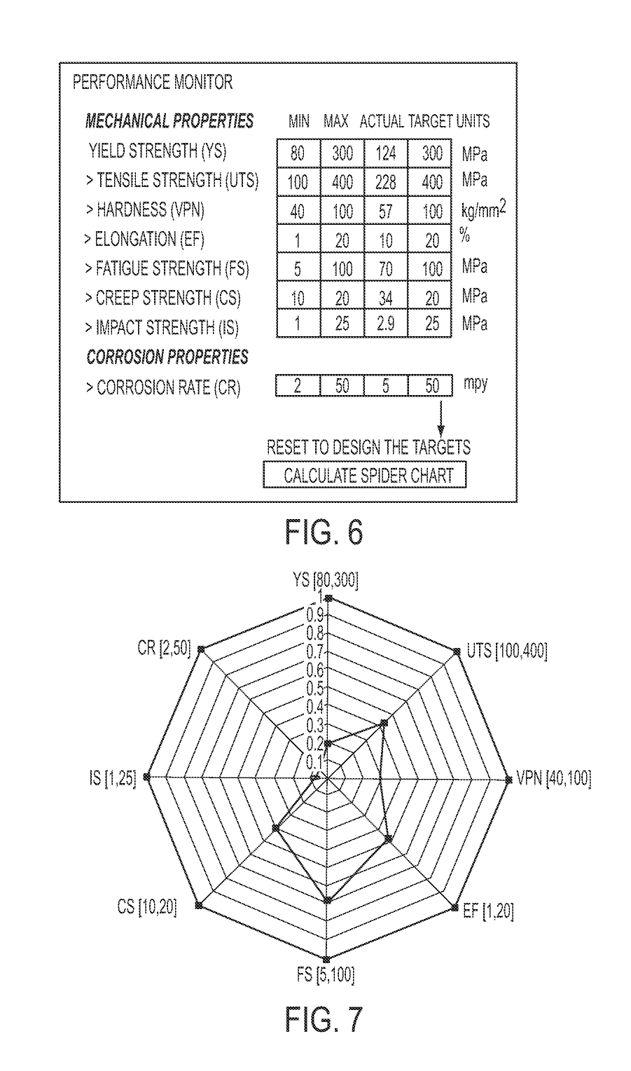

Referring next to FIGS. 6 and 7, material selection and alloy design preferences may be input (such as through one or more input devices 120) into computer 100 of FIG. 1, where FIG. 6 represents a notional input screen or related property input mechanism. In one form, the GUI shown in FIG. 6 provides the input window for a user to define the target material properties. After searching, the computer 100 will output the actual properties of one alloy that is very close to target properties. Referring with particularity to FIG. 7, a spider chart shows normalized values of properties that are used via the input of FIG. 6, including yield strength YS, ultimate tensile strength UTS, hardness VHN, elongation EF, fatigue strength FS, creep strength CS, impact strength IS and corrosion rate CR. The spider chart is to show the difference between the alloy properties and the targeted properties that occupy the chart's outline region; such a chart offers a direct illustration of how good the design is. In one form, the spider chart may be output to user-recognizable form, such as through output 130 of computer 100, as well as to machine-readable format via memory 140.

The fourth of the functional modules is the mechanical property module 500. The global uniform mechanical properties are predicted based on the materials property database 800 from various sources such as known material property handbooks; such information may be provided by the alloy compositions and designation database 600 discussed above. In contrast, the local mechanical properties may be calculated by taking into consideration multi-scale defects and microstructures on a node-by-node basis; information may come from the defects & microstructure module 900. The nodal-based multi-scale defect (for example, porosity) and microstructure (for example, DAS) information is needed to establish the localized material property prediction. Module 500 can either search for material properties from the materials property database 800 for a given alloy (composition) provided by input from the alloy compositions and designation database 600, or perform nodal property calculations for each node based on information taken from the defect & microstructure module 900 and alloy compositions and designation database 600. It should be noted that the searched material properties will be generic and uniform property data.

In addition to the input from the defects & microstructure module 900, module 500 receives input from the casting process simulation module 1000 (also called casting modeling, casting simulation or the like) such that the detailed mold filling and solidification processes are simulated. The velocity, thermal and pressure information calculated during casting process is used for prediction of defects and microstructure. The casting process simulation module 1000 may be in the form of numerous commercially-available software packages, including MAGMA, ProCAST, EKK, WRAFTS, Anycasting or the like. Such software typically has several modules that can simulate casting mold filling, solidification, core molding (blowing) and related functions, which combine to determine the distribution of defects and microstructures in a casting. The casting simulation is also configured to deliver nodal numbers as well as their corresponding nodal coordinates (for example, x, y and z coordinates from a Cartesian coordinate system) to one or more of the modules 200 through 500.

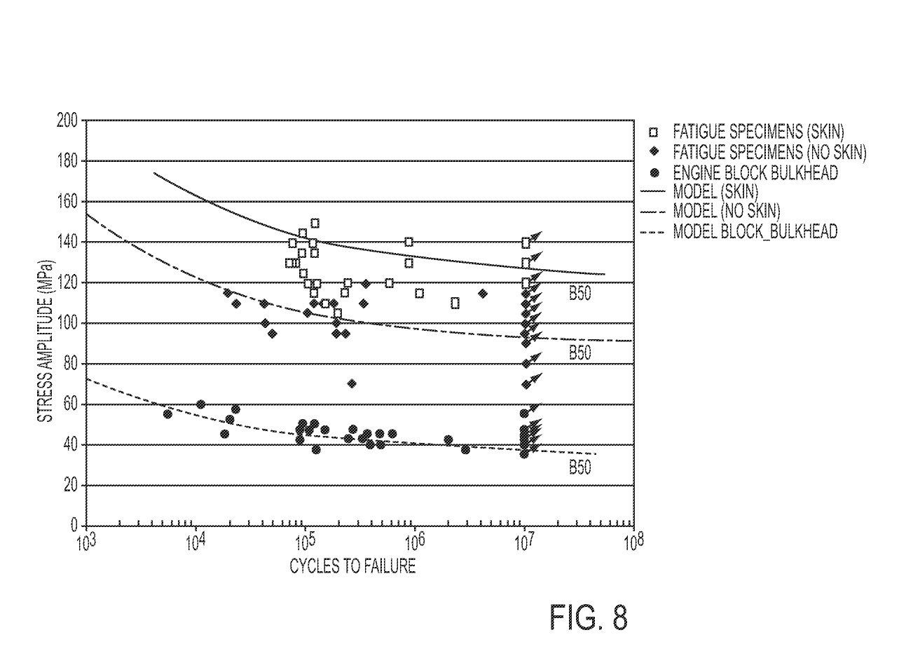

Referring with particularity to FIG. 8, a chart shows room temperature fatigue properties of a particular alloy (specifically, Alloy A380) used for a high pressure die casting (HPDC) simulation, including comparisons between actual specimens or samples and their modeled counterparts through an embodiment of the present invention. The fatigue properties of FIG. 8 may be determined by the following equations

$${σ}_{a} = {σ}_{L} + exp ( \frac{ln ( {a}_{ECD} \cdot {N}_{f} ) - {C}_{0}}{{C}_{1}} )$$

$${σ}_{L} = Δ {K}_{eff , th} / ( 2 Y ( {a}_{ECD} ) \cdot {U}_{R} ( {a}_{ECD} ) \cdot \sqrt{π {a}_{ECD} / 1000000} )$$

where σₐ represents the applied stress or fatigue strength at a given life cycle, σₗ represents the infinite life fatigue strength, C₀ and C₁ are material-dependent empirical constants, a_{ECD} is an equivalent circle diameter of a defect or pore formed in the casting, N_{f} is fatigue life, U_{R}(a_{ECD}) is a crack closure correction and K_{eff th} is an effective threshold stress intensity factor of a material used in the casting. It will be appreciated by those skilled in the art that exemplary coefficients and constants (not shown) may be used in conjunction with the fatigue life model. The specimens tested (shown as the geometric shapes corresponding to squares, diamonds and circles) include those respectively with and without skin, as well as an engine block bulkhead region; comparable modeled material property predictions are shown with solid line and two different dashed lines.

In one form, the nodal mapping and calibrating function (sometimes referred to herein as MATerial GENeration, or MATGEN) includes reading the node number and corresponding nodal coordinates (such as the aforementioned {x, y, z} coordinates in a Cartesian system) of the cast aluminum component of interest; details of this system may be found in U.S. Pat. No. 8,666,706 that is incorporated herein by reference and owned by the Assignee of the present invention. Such a material property generation program can read in (or otherwise accept, such as in text format) nodal level values from a casting process simulation software (such as the one or more of the ones mentioned above) that may include routines to consider the casting defects & microstructure module 900. Thus, upon generation of the localized (i.e., node-by-node) material properties that include the effects of porosity and DAS, module 500 can output the information for subsequent designer or modeler use. In one preferred form, the nodal mapping and calibrating function of MATGEN may be used in conjunction with the present invention, in particular being a part of module 500 as well as the substantial entirety of modules 900 and 1000. In a more preferred form, the nodal-based property calculations are actually performed by MATGEN.

Referring again to FIG. 2, output from module 200 contains at least phase diagrams, solidification sequences and phase constituents as a function of temperature. For module 300, the output contains at least key thermal physical properties of a given alloy as a function of temperature. Likewise, for mechanical property module 500, the output contains at least mechanical (such as tensile and fatigue) properties of a given alloy as a function of temperature. In addition, for module 400, the output box shows at least the alloy selected or designed based on the property requirements. The output of any or all of these modules may be in the form of graphs or tables in suitable user-readable format, or user or machine-readable data files.

In summary, specific attributes of the present invention include multiple abilities, including the ability to (1) integrate all of the prediction capabilities into a single computational platform, (2) take solid back diffusion into consideration when conducting phase calculations, (3) employ a k-nearest neighbor model for the module used to make thermal-physical property calculations, and (4) generate local mechanical property (including multi-axial fatigue, etc) data in order to (5) optimize the selection of a material for a particular component.

It is noted that recitations herein of a component of an embodiment being “configured” in a particular way or to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural factors of the component. Likewise, for the purposes of describing and defining embodiments herein it is noted that the terms “substantially”, “significantly” and “approximately” are utilized herein to represent the inherent degree of uncertainty that may be attributed to any quantitative comparison, value, measurement, or other representation, and as such may represent the degree by which a quantitative representation may vary from a stated reference without resulting in a change in the basic function of the subject matter at issue.

Having described embodiments of the present invention in detail, and by reference to specific embodiments thereof, it will be apparent that modifications and variations are possible without departing from the scope of the embodiments defined in the appended claims. More specifically, although some aspects of embodiments of the present invention are identified herein as preferred or particularly advantageous, it is contemplated that the embodiments of the present invention are not necessarily limited to these preferred aspects.

What is claimed is:

1. A device for predicting properties of a material used in a cast aluminum component, said device comprising:
a data input, a data output, at least one processing unit and at least one of data-containing memory and instruction-containing memory that are cooperative with one another through a data communication path; and
a plurality of computation modules programmably cooperative with at least one of said data input, data output, processing unit and memories through said data communication path such that upon receipt of data pertaining to said component and said material, said device subjects said data to said plurality of modules in order that output data generated thereby provides performance indicia of said material, said modules comprising:
a thermodynamic calculation module configured to receive data from a thermodynamic database that corresponds to said material;
a thermal-physical property module configured to (a) receive data from said input that corresponds to said material and (b) exchange data with said thermodynamic calculation module;
a mechanical property module configured to receive (a) data from said input that corresponds to said material and (b) data from at least one of (i) a casting process simulation and (ii) defects and microstructure calculations; and
a materials selection or alloy design module configured to (a) exchange data with said thermodynamic calculation module, thermal-physical property module and mechanical property module and (b) convey data that corresponds to said material to said output.

2. The device of claim 1, wherein said thermodynamic calculation module and said thermodynamic database cooperate to process a plurality of cooling rate conditions selected from the group consisting of equilibrium, partial non-equilibrium and non-equilibrium conditions.

3. The device of claim 2, wherein said non-equilibrium condition comprises a solid back diffusion model to predict at least one of actual phase fractions and phase diagrams that correspond to said material in said component.

4. The device of claim 3, wherein said equilibrium condition uses a lever rule calculation and said partial non-equilibrium condition uses a Schiel calculation.

5. The device of claim 1, wherein said mechanical property module performs property mapping on a node-by-node basis.

6. The device of claim 5, wherein said mechanical property module further cooperates with a database configured to provide local microstructure fineness and defect information to provide a prediction of actual local and global tensile and fatigue properties of said input that corresponds to said material.

7. The device of claim 1, wherein said thermal-physical property module calculates material thermal properties using a k-nearest neighbor model.

8. The device of claim 1, wherein said materials selection or alloy module is configured to accept physical and mechanical properties selected from the group consisting of (a) optimized aluminum alloy compositions and (b) target physical and mechanical properties.

9. An article of manufacture comprising a computer usable medium having computer readable program code embodied therein for predicting properties of a material used in a cast aluminum component, said computer readable program code in said article of manufacture comprising:
computer readable program code portion for causing said computer to accept input information from at least one of a plurality of databases;
computer readable program code portion for causing said computer to perform at least one thermodynamic calculation for said material based on at least a portion of said accepted information;
computer readable program code portion for causing said computer to perform at least one thermal-physical calculation for said material based on at least a portion of said accepted information;
computer readable program code portion for causing said computer to perform at least one mechanical property calculation for said material based on at least a portion of said accepted information; and
computer readable program code portion for causing said computer to perform at least one materials selection or alloy design calculation for said material based on (a) at least a portion of said accepted information and (b) input from at least one of said thermodynamic calculation, thermal-physical property calculation and mechanical property calculation such that data that corresponds to said predicted material properties is conveyed to a computer output.

10. The article of manufacture of claim 9, wherein said plurality of databases comprises an alloy compositions and designation database, a thermodynamic database, a materials property database and a defects and microstructure database.

11. The article of manufacture of claim 10, wherein said computer readable program code portion for causing said computer to perform at least one thermodynamic calculation further comprises computer readable program code portion for predicting a plurality of cooling rate conditions selected from the group consisting of equilibrium, partial non-equilibrium and non-equilibrium conditions.

12. The article of manufacture of claim 11, wherein said non-equilibrium condition comprises a solid back diffusion model to predict at least one of actual phase fractions and phase diagrams that correspond to said material.

13. The article of manufacture of claim 10, wherein said computer readable program code portion for causing said computer to perform at least one mechanical property calculation comprises peforming property mapping on a node-by-node basis for a component shape that correspond to said material.

14. The article of manufacture of claim 13, wherein said computer readable program code portion for causing said computer to perform at least one mechanical property calculation further comprises computer readable program code portion for calculating local and global tensile and fatigue properties based on said defects and microstructure database.

15. The article of manufacture of claim 13, wherein said computer readable program code portion for causing said computer to perform at least one mechanical property calculation further comprises computer readable program code portion for accepting as input (a) a casting process simulation and (b) information from said defects and microstructure database.

16. The article of manufacture of claim 10, wherein said computer readable program code portion for causing said computer to perform at least one thermal-physical calculation comprises further comprises computer readable program code portion for using a k-nearest neighbor-based regression model to provide a thermal property prediction that corresponds to said material.

17. The article of manufacture of claim 10, wherein said computer readable program code portion for causing said computer to perform at least one materials selection or alloy calculation further comprises computer readable program code portion for accepting physical and mechanical properties selected from the group consisting of (a) optimized aluminum alloy compositions and (b) target physical and mechanical properties.
